(19) United States
(12) Patent Application Publication
(10) Pub. No.: US 2010/0282719 A1
(43) Pub. Date: Nov. 11, 2010

(54) VENTED SHIM BEAM WELDING PROCESS

(75) Inventors: Daniel Anthony Nowak, Greenville, SC (US); Attila Szabo, Greenville, SC (US)

Correspondence Address: Hoffman Warnick LLC, 75 State Street, Floor 14, Albany, NY, 12207, US

(73) Assignee: GENERAL ELECTRIC COMPANY, Schenectady, NY (US)

(21) Appl. No.: 12/435,430

(22) Filed: May 5, 2009

(51) Int. Cl. B23K 15/00

(52) U.S. Cl. 219/121.14; 219/121.13

(57) ABSTRACT

A method and system are disclosed for beam welding two members made of a metallic material. The method comprising placing a first shim along a weld joint faying surface between the two members of the metallic material, placing a second shim along the weld joint faying surface between the two members of the metallic material and at a distance from the first shim to create a first vent path between the first and the second shim and beam welding the members of the metallic material with the shim to create a porosity free weld.

### BACKGROUND OF THE INVENTION

The subject matter disclosed herein relates generally to welding and more specifically to a vented shim beam welding process. A weld containing porosity may be formed when materials are beam welded together and there is no mechanism for gases that are created during the welding process to escape from the weld pool. The formation of a weld containing porosity may be more likely to be formed when thick pieces of materials are joined. The thicker a piece of material, the greater likelihood that during welding that there will be the formation of gases that evolved during the welding process that are unable to escape and thus result in the formation of a weld containing porosity.

FIG. 1 shows an illustrative prior art approach to welding two material members 102 together using a shim 104. FIG. 1 shows how shim 104 is placed along a weld joint faying surface 106 between the two material members 102. FIG. 2 shows the prior art including a cross-sectional view of a weld 204 containing porosity 202.

### BRIEF DESCRIPTION OF THE INVENTION

A method and system are disclosed for beam welding two members made of a metallic material. The method comprising placing a first shim along a weld joint faying surface between the two members of the metallic material, placing a second shim along the weld joint faying surface between the two members of the metallic material and at a distance from the first shim to create a first vent path between the first and the second shim and beam welding the members of the metallic material with the shims to create a porosity free weld.

A first aspect of the invention provides a method for beam welding two members made of a metallic material, the method comprising placing a first shim along a weld joint faying surface between the two members of the metallic material, placing a second shim along the weld joint faying surface between the two members of the material and at a distance from the first shim to create a first vent path between the first and the second shim and beam welding the members of the metallic material with the shims to create a porosity free weld.

A second aspect of the invention provides a welding shim system for use in welding two members of metallic y material, the system comprising a first shim having an angled edge for placement within a plane of a weld joint faying surface between the two members of the metallic material, a second shim having a complementary angled edge to the angled edge of the first shim for placement within the plane of the weld joint faying surface between the two members of the metallic material and an element on at least one of the first and second shims for positioning the shims such that a first vent path exists between the angled edge and the complimentary angled edge.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a perspective view of two members made of a metallic material with a shim therebetween according to the prior art.

FIG. 2 shows a cross-sectional view of the members of FIG. 1 illustrating the joint formed between the members and the porosity entrapped in the weld metal.

FIG. 3 shows a perspective view of a member made of a metallic material with shims that include vent paths between the shims.

FIG. 4 shows a cross-sectional view of a porosity free joint formed using the shims of FIG. 3.

FIG. 5 shows a cross-sectional view of two members made of a metallic material being beam welded with one of the members in phantom to expose the weld progression.

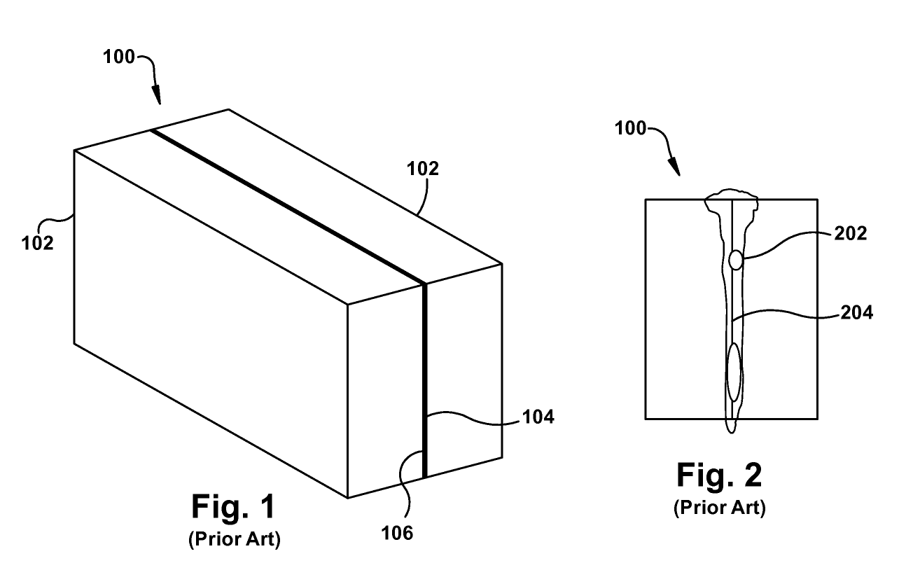

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

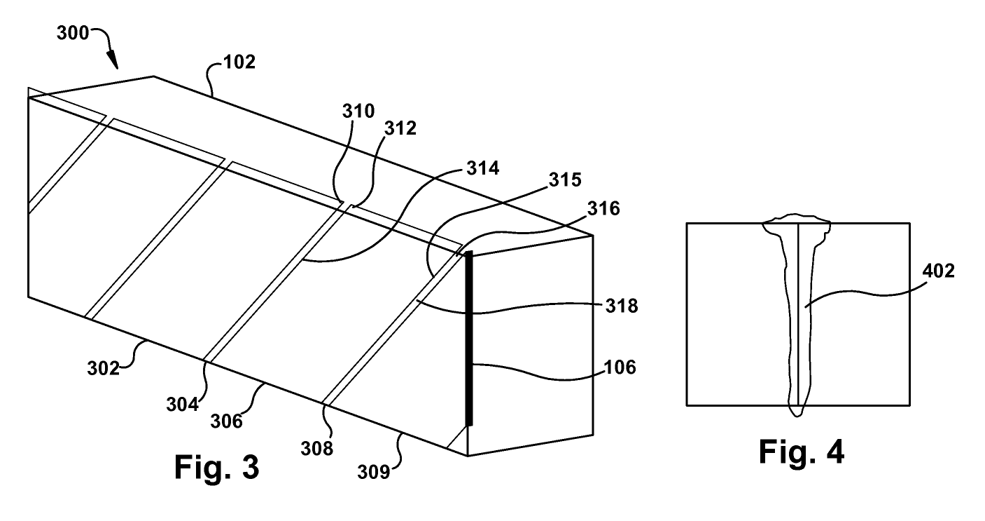

The removal of gases created during the welding of metallic materials is advantageous to the welding process as it reduces the possible formation of porosity in the weld. One way to remove these gases is through a vent path that is created using shims. The shims may already be present as part of the welding process. The shims may be arranged to create a vent path for the removal of gases created during welding. Turning to the drawings, FIG. 3 shows an embodiment of the invention wherein there is a metallic material member 102 that includes a welding joint faying surface 106, and a first metallic shim 302 adjacent to a second metallic shim 306 with a first vent path 304 therebetween. Gases created during the welding process may be removed from the metallic material member 102 ahead of the weld pool through vent path 304.

In one embodiment, there is a welding shim system for use in welding two members 102 of metallic material. The system may comprise first metallic shim 302 having an angled edge 310 for placement within a plane of weld joint faying surface 106 between the two members 102 of the metallic material, a second metallic shim 306 having a complementary angled edge 312 to angled edge 310 of first metallic shim 302 for placement within the plane of the weld joint faying surface 106 between the two members 102 of the metallic material. Additionally, the system may have an element 314 on at least one of first metallic shim 302 or second metallic shim 306 for positioning the shims such that first vent path 304 exists between angled edge 310 and complimentary angled edge 312. In an additional embodiment, first shim 302 and second shim 306 each include a metallic material. The material of the shim, the angle cut on the shim, and the gap spacing of the shim are correlated to the welding parameters and the metallic material being joined. The welding parameters may include, as an example, controlling the power to the electron beam, current to the electron beam, travel speed of the beam, oscillation, frequency and focus. In an alternative embodiment, each metallic shim has a substantially parallelogram shape. In a further embodiment, angle edge 310 and complimentary angle edge 312 are approximately 20 to 60 degrees relative to a beam welding angle.

In a further embodiment, a third metallic shim 309 or any number of additional shims may be provided having a second complementary angled edge 316 to a second angle edge 315 of an adjacent second shim 306 (in this case, second metallic shim) for placement within the plane of the weld joint faying surface 106 between the two members 102 of the metallic material. An element 318 may be provided on at least one of second shim 306 or third shim 309 for positioning the shims such that a second vent path 308 exists between second complimentary angled edge 318 and second angled edge 315.

First vent path 304 and second vent path 308 allow gases created during the welding process to escape ahead of the weld pool. In one embodiment, the first shim and the second shim may be separated from one another by a space of up to 0.100 inch. As welding progresses along metallic material member 102, gases created during the welding process may be channeled through vent paths 304, 308 ahead of the weld pool. Allowing the gases to escape during the welding process may reduce or eliminate the creation of a weld containing porosity 202 (FIG. 2). Consequently, allowing the gases from the welding process to be channeled away through vent paths 304, 308 may result in a porosity free weld, as illustrated in FIG. 4. A porosity free weld 402 is a preferred weld between two or more metallic materials.

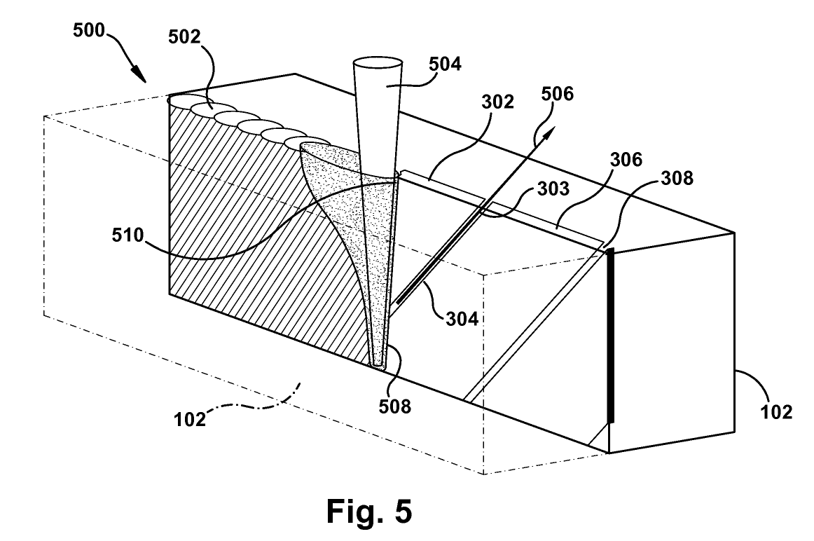

Turning to FIG. 5, an additional embodiment where a beam welder 504 would weld two metallic material members 102 using shims 302, 306 that have vent path 304 between adjacent shims 302, 306 is illustrated. As beam welder 504 progresses along metallic material member 102, it produces a porosity free weld 502. As beam welder 504 progresses along metallic material member 102, a weld front 508 contacts second shim 306 and second vent path 308 before reaching an end 303 of the first vent path 304. That is, first vent path 304 terminates sufficiently close enough to second vent path 308 such that a vent path is always available. This process ensures that at every stage, welding gases 506 produced by the welding process are able to be channeled out ahead of the weld pool 510. By aligning the shims 302, 306 along weld joint faying surface 106 so there is always vent path 304, 308 for the escape of gases 506 from beam welder 504, shims 302, 306 reduce the possibility of creating a weld with porosity 202 (FIG. 2) and increases the likelihood of producing a porosity free weld 402 (FIG. 4). The weld of metallic material members 102 and shim 104 can be made using a beam weld 504. In one embodiment, the beam weld 504 can be an electron beam. In an alternative embodiment, the beam weld 504 can be a laser beam.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of beam welding two members made of a metallic material, the method comprising:
placing a first shim along a weld joint faying surface between the two members of the metallic material;
placing a second shim along the weld joint faying surface between the two members of the metallic material and at a distance from the first shim to create a first vent path between the first and the second shim; and
beam welding the members of the metallic material with the shims to create a porosity free weld.

2. The method of claim 1, wherein the first and the second shim each include a metallic material.

3. The method of claim 1, further comprising placing a third shim along the weld joint faying surface and at a distance from the second shim to create a second vent path between the second and the third shim.

4. The method of claim 3, further comprising aligning the first vent path with the weld joint faying surface such that as the first vent path is consumed by a weld pool, the second vent path is available to provide a channel for gases from the welding to escape ahead of the weld pool.

5. The method of claim 1, wherein the first shim and the second shim are separated from one another by a space of up to 0.100 inch.

6. The method of claim 1, wherein the beam welding includes controlling power to a beam welder based on the metallic material being joined.

7. The method of claim 1, wherein the beam welding includes controlling current to a beam welder based on the metallic material being joined.

8. The method of claim 1, wherein the beam welding includes controlling a travel speed of a beam welder based on the metallic material being joined.

9. The method of claim 1, wherein the angle edge and the complementary angle edge are approximately 20 to 60 degrees relative to a beam welding angle.

10. The method of claim 1, wherein the beam welding includes using electron beam welding.

11. The method of claim 1, wherein the beam welding includes using laser beam welding.

12. A welding shim system for use in welding two members of a metallic material, the system comprising:
a first shim having an angled edge for placement within a plane of a weld joint faying surface between the two members of the metallic material;
a second shim having a complementary angled edge to the angled edge of the first shim for placement within the plane of the weld joint faying surface between the two members of the metallic material; and
an element on at least one of the first and second shims for positioning the shims such that a first vent path exists between the angled edge and the complimentary angled edge.

13. The system of claim 12, wherein the first and the second shim each include a metallic material.

14. The system of claim 12, further comprising a third shim having a second complementary angled edge to a second angle edge of the second shim for placement within the plane of the weld joint faying surface between the two members of the metallic material.

15. The system of claim 14, further comprising an element on at least one of the second and third shims for positioning the shims such that a second vent path exists between the second complimentary angled edge and the second angled edge.

16. The system of claim 12, wherein the angled edge and the complimentary angled edge are separated from one another by a space of up to 0.100 inch.

17. The system of claim 12, wherein each shim has a substantially parallelogram shape.

18. The system of claim 12, wherein the angle edge and the complementary angle edge are approximately 20 to 60 degrees relative to a beam welding angle.
